(19) United States
(12) Patent Application Publication
(10) Pub. No.: US 2013/0180910 A1
(43) Pub. Date: Jul. 18, 2013

(54) Rotary-wing shaped fiber filter material

(71) Applicant: Pulun Lu, Ningbo (CN)

(72) Inventor: Pulun Lu, Ningbo (CN)

(21) Appl. No.: 13/201,858

(22) Filed: Aug. 17, 2011

(30) Foreign Application Priority Data
Jan. 14, 2009 (CN) 200910000504.2
Jan. 8, 2010 (CN) PCT/CN2010/070070

(51) Int. Cl. B01D 39/02

(52) U.S. Cl. CPC B01D 39/02
USPC 210/483

(57) ABSTRACT

A rotary-wing shaped fiber filter material includes a fiber bundle (1) composed of fibers and a rotary-wing core (2). The fiber bundle (1) perforates through the center of the rotary-wing core (2) by injection moulding and consolidates. A fiber joint (3) is set on the fiber bundle (1) and located at the position where the fiber bundle (1) and the rotary-wing core (2) consolidate. The fiber joint (3) can be a joint formed by knotting the fibers, a joint where the fibers intersect, a joint where the fibers fold, or a joint where a fiber binds other fibers.

### CROSS REFERENCE OF RELATED APPLICATION

This is a continuation of the International Application PCT/CN2010/070070 filed on 8 Jan. 2010, which claims the benefit of CN 200910000504.2 and priority date of 14 Jan. 2009.

### BACKGROUND OF THE PRESENT INVENTION

1. Field of Invention

The present invention relates to a filter material for water, and more particularly to a new-type rotary-wing shaped fiber filter material.

2. Description of Related Arts

In conventional filter processes, the filter materials are mostly solid particle-shaped filter materials, such as sand, anthracite, active carbon, ceramic balls, and plastic rings. The foregoing filter materials has small specific surface area, and can contain small amount of dirt on the filter bed, and thus has low filter precision and filter speed.

Synthetic fiber filter materials have great progress as comparing with the solid particle-shaped filter materials. The prior synthetic fiber filter materials, e.g., a filter material disclosed in Chinese patent application, AN CN00107758.9, PN CN1273872, take the advantage of large specific surface area, adjustable void volume of filter bed of fibers, so as to overcome the drawbacks that the filter beds of the spherical fiber filter materials have uneven compactness, and bad backflushing effect. However, they do not solve the problems that the filter material wraps on the retainer of filter devices, has poor ability to adapt for different medium, bad backflushing effect, low use ratio of the filter bed, and weak connection strength (easy to detach) between filter material cores and fiber bundles.

### SUMMARY OF THE PRESENT INVENTION

An object of the present invention is to provide a new-type rotary-wing shaped fiber filter material, which has high filter precision, big containing of dirts on the filter bed, good ability to adapt for different medium, good backflushing effect, small chance to wrap on the retainer of filter devices, big use ration of the filter bed, strong connection strength between the filter material cores and fibers, and more bouffant fiber bundles.

Accordingly, in order to accomplish the above objects, the present invention provides a new-type rotary-wing shaped fiber filter material, comprising:

a fiber bundle consisting of fibers; and

a rotary-wing core, which is formed by injection, wherein the fiber bundle passes through a center of the rotary-wing core and forms an integration therewith, wherein the fiber bundle has a fiber joint provided at a connection position of the fiber bundle and the rotary-wing core.

Preferably, the fiber joint is a joint formed by knotting the fibers, or crossing of the fibers, or bending the fibers, or tying a fiber to other fibers.

Preferably, the fiber joint and the fiber bundle are made of a same material or two different materials.

Preferably, the fiber bundle is arranged in straight line, or several fiber bundles are crossed on a plane or tridimensionally, with respect to the fiber joint. The rotary-wing core can be one or more in series on the fiber bundles, or at the crossing of the fiber bundles on the plane or tridimensionally.

Preferably, the rotary-wing core is an integration having a plurality of rotary wings provided on a core.

Particularly, the core of the rotary-wing core is spherical, ellipsoidal, or other polyhedron.

Particularly, the rotary wings of the rotary-wing core are shaped as wing bodies outside the core or grooves on the core.

Particularly, the rotary wings of the rotary-wing core rotate leftward or rightward, wherein a rotating angle thereof is −45°˜45°.

Preferably, the lengths of the fiber bundle can be same or different on two sides of the rotary-wing core, or the fiber bundle in on a single side of the rotary-wing core.

Preferably, the fiber bundle can be shaped as a straight line, a curly line, a hollow line or a heteromorphic line.

Preferably, the fibers can be natural fiber, rayon, synthetic fiber, cotton fiber, fiberglass, terylene, Nitrilon, or Jinglun.

Preferably, the rotary-wing core is made by plastic, ceramic, glass, rubber or metal materials.

Due to the foregoing technical proposal, the present invention has the following advantages:

1. The fiber joint according to the present invention is formed by knotting the fibers, or crossing of the fibers, or bending a fiber, or tying a fiber to other fibers, and the joint of the fiber bundles and the fiber joint is wrapped and fixedly connected by the rotary-wing core. Therefore, the fiber bundles are not easy to detach, have high connection strength, are hardly loosened, knotted or grouped.

2. The rotary-wing shaped fiber filter material according to the present invention has good backflushing effect, saves water and energy, and adapts to mechanization production. Besides, the fiber bundles have big volume ratio, so that the filter bed has high plot ratio and high filter speed.

### BRIEF DESCRIPTION OF THE DRAWINGS

FIG. 1 is a sketch view of a joint formed by knotting fibers according to a preferred embodiment of the present invention.

FIG. 1-a is a sketch view of a rotary-wing core rotating leftward in FIG. 1.

FIG. 1-b is a sketch view of a rotary-wing core having upper rotary wings rotating rightward and lower rotary wings rotating leftward in FIG. 1.

FIG. 2 is a sketch view of a joint formed by crossing the fibers according to a preferred embodiment of the present invention.

FIG. 2-a is a sketch view of a rotary-wing core rotating rightward in FIG. 2.

FIG. 2-b is a sketch view of a rotary-wing core having upper rotary wings rotating rightward and lower rotary wings rotating leftward in FIG. 2.

FIG. 3 is a sketch view of a joint formed by tying a fiber to other fibers according to a preferred embodiment of the present invention.

FIG. 3-a is a sketch view of a rotary-wing core rotating leftward in FIG. 3.

FIG. 3-b is a sketch view of a rotary-wing core having upper rotary wings rotating rightward and lower rotary wings rotating leftward in FIG. 3.

Reference characters: 1—fiber bundle; 2—rotary-wing core; 3—fiber joint.

### DETAILED DESCRIPTION OF THE PREFERRED EMBODIMENT

One skilled in the art will understand that the embodiment of the present invention as shown in the drawings and described above is exemplary only and not intended to be limiting.

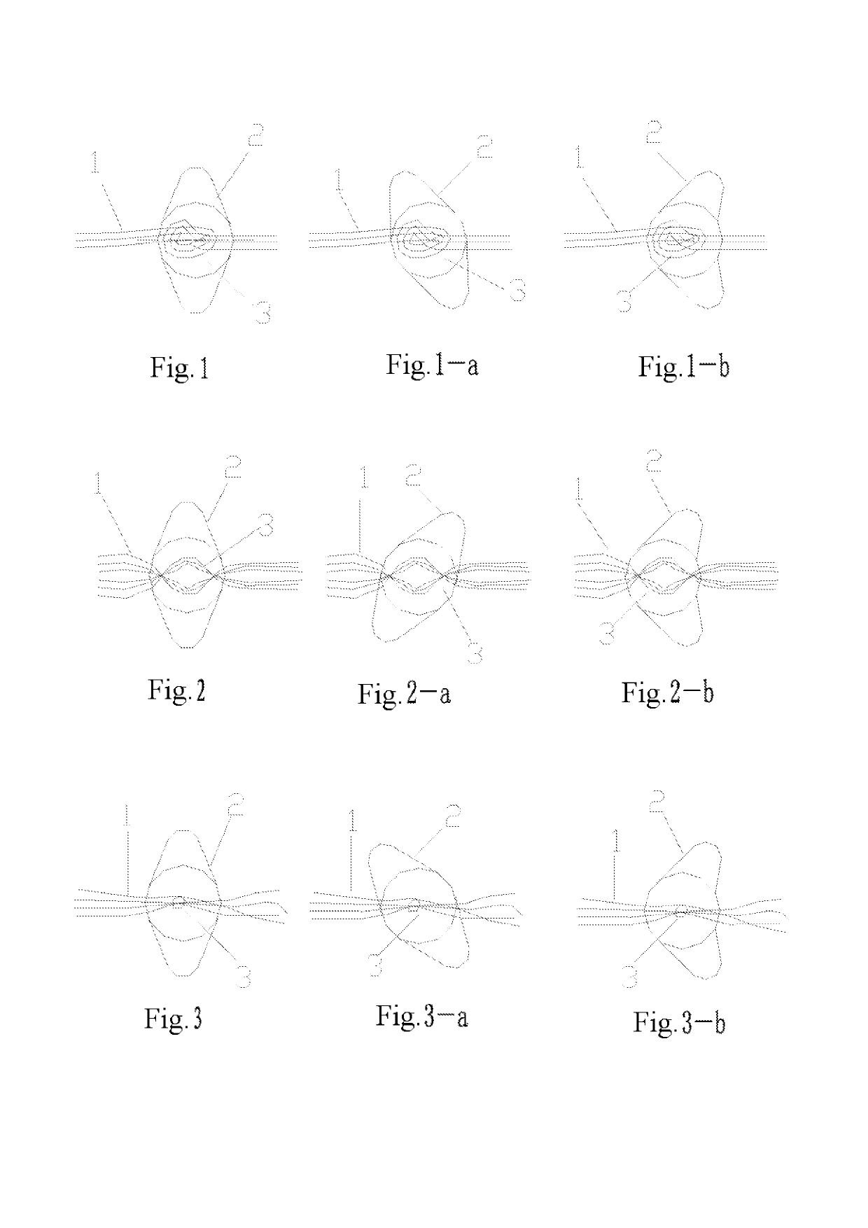

Referring to FIGS. 1-3 of the drawings, a new-type rotary-wing shaped fiber filter material according to a preferred embodiment of the present invention is illustrated, comprising a fiber bundle 1 consisting of fibers; and a rotary-wing core 2, which is formed by injection, wherein when injection, the fiber bundle 1 passes through a center of the rotary-wing core 2 and forms an integration therewith after cooling, wherein the fiber bundle 1 has a fiber joint 3 provided at a connection position of the fiber bundle 1 and the rotary-wing core 2.

Preferably, the fiber joint 3 is a joint formed by knotting the fibers (as shown in FIG. 1), or crossing of the fibers (as shown in FIG. 2), or bending the fibers, or tying a fiber to other fibers (as shown in FIG. 3). The fiber joint 3 and the fiber bundle 1 are made of a same material or two different materials.

Preferably, the fiber bundle 1 is arranged in straight line, or several fiber bundles 1 are crossed on a plane or tridimensionally, with respect to the fiber joint 3. The rotary-wing core 2 can be one or more in series on the fiber bundles 1, or at the crossing of the fiber bundles 1 on the plane or tridimensionally.

Preferably, the rotary-wing core 2 is an integration having a plurality of rotary wings provided on a core. The core of the rotary-wing core 2 is spherical, ellipsoidal, or other polyhedron. The rotary wings of the rotary-wing core 2 are shaped as wing bodies outside the core or grooves on the core. The rotary wings of the rotary-wing core 2 rotate leftward or rightward, wherein a rotating angle thereof is −45°˜45°.

Preferably, the lengths of the fiber bundle 1 can be same or different on two sides of the rotary-wing core 2, or the fiber bundle 1 in on a single side of the rotary-wing core 2.

Preferably, the fiber bundle 1 can be shaped as a straight line, a curly line, a hollow line or a heteromorphic line.

Preferably, the fibers can be natural fiber, rayon, synthetic fiber, cotton fiber, fiberglass, terylene, Nitrilon, or Jinglun.

Preferably, the rotary-wing core 2 is made by plastic, ceramic, glass, rubber or metal materials.

Preferably, in the preferred embodiment, the number of the rotary wings is two; the lengths of the fiber bundle 1 are different on two sides of the rotary-wing core 2; the fiber bundle 1 is shaped as a straight line.

A procedure of applying the present invention to a backflushing filter device is as follows.

The filter material is a double rotary-wing shaped fiber filter material which is made of synthetic fiber bundle 1, has the fiber bundle 1 of different lengths on two sides of the spherical rotary-wing core 2, and is rotating rightward for 30°. The rotary-wing core 2 is formed by hot-pressing. The filter materials are placed in a filter chamber, and have two or more different lengths. And the length of the shortest fiber bundle 1 does not exceed a height of a retainer of the filter device, and after compressing, a thickness of the shortest rotary-wing shaped fiber filter material should be bigger than the height of the retainer of the filter device, so as to effectively solve the problem that the fiber bundles 1 wrap on the retainer. The filter materials is loaded to ⅓˜⅔ of an effective height of the filter chamber, and since a specific gravity of plastic is bigger than the fiber bundles 1, the shorter filter material sinks to a surface layer of the retainer of the filter chamber. Filter water enters via an entrance pipe, and the filter material is compressed on the retainer, and thus the void volume of the filter chamber decreases from top to bottom, and use ratio of the filter material of the filter chamber is raised, a dirt containing of the filter bed is increased. First filter water is exhausted by a first water exhaust pipe, and after the first filter water reaches the standard, the first water exhaust pipe is closed, an exhaust pipe is opened, and water is supplied normally. When the dirt containing of the filter bed formed by the filter material reaches to a certain value, the entrance pipe is closed, a backflushing pipe is opened to backflush the filter material. Under strong impact of water and air, the filter bed swells, the filter material floats upwardly, the fiber bundles 1 are loosened. Because the filter material is the spherical double rotary-wing shaped fiber filter material which is made of synthetic fiber bundle 1, rotates rightward for 30°, and have different lengths on two sides, the double rotary wings drive the fiber bundle 1 to rotate, sway and impact each other uncertainly, so as to accelerate detaching suspension particles attached on the fiber bundle 1, increase cleaning speed of the filter material, saves water and energy for backflushing. The dirty water after backflushing is exhausted by a drain pipe, and the filter material is blocked by a blocking net. After exhausting the dirty water, clean water enters via the entrance pipe to accomplish a working circle.

The rotary-wing shaped fiber filter material according to the present invention has high fixed connection strength, good backflushing effect, saves water and energy, adapts to mechanization production. Besides, the fiber bundles 1 have big volume ratio, so that the filter bed has high plot ratio and high filter speed.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

1-10. (canceled)

11. A new-type rotary-wing shaped fiber filter material, comprising:
a fiber bundle consisting of fibers; and
a rotary-wing core, which is formed by injection, wherein said fiber bundle passes through a center of said rotary-wing core and forms an integration therewith, wherein said fiber bundle has a fiber joint provided at a connection position of said fiber bundle and said rotary-wing core.

12. The new-type rotary-wing shaped fiber filter material, as recited in claim 11, wherein said fiber joint is a joint formed by knotting said fibers, or crossing of said fibers, or bending said fibers, or tying a fiber to other fibers.

13. The new-type rotary-wing shaped fiber filter material, as recited in claim 12, wherein said fiber joint and said fiber bundle are made of a same material or two different materials.

14. The new-type rotary-wing shaped fiber filter material, as recited in claim 13, wherein said fiber bundle is arranged in straight line, or several fiber bundles are crossed on a plane or tridimensionally, with respect to said fiber joint, said rotary-wing core is one or more in series on said fiber bundles, or at said crossing of said fiber bundles on said plane or tridimensionally.

15. The new-type rotary-wing shaped fiber filter material, as recited in any of claims 11, wherein said rotary-wing core is an integration having a plurality of rotary wings provided on a core.

16. The new-type rotary-wing shaped fiber filter material, as recited in any of claims 12, wherein said rotary-wing core is an integration having a plurality of rotary wings provided on a core.

17. The new-type rotary-wing shaped fiber filter material, as recited in any of claims 13, wherein said rotary-wing core is an integration having a plurality of rotary wings provided on a core.

18. The new-type rotary-wing shaped fiber filter material, as recited in any of claims 14, wherein said rotary-wing core is an integration having a plurality of rotary wings provided on a core.

19. The new-type rotary-wing shaped fiber filter material, as recited in claim 15, wherein said core of said rotary-wing core is spherical, ellipsoidal, or other polyhedron.

20. The new-type rotary-wing shaped fiber filter material, as recited in claim 16, wherein said core of said rotary-wing core is spherical, ellipsoidal, or other polyhedron.

21. The new-type rotary-wing shaped fiber filter material, as recited in claim 19, wherein said rotary wings of said rotary-wing core are shaped as wing bodies outside said core or grooves on said core.

22. The new-type rotary-wing shaped fiber filter material, as recited in claim 20, wherein said rotary wings of said rotary-wing core are shaped as wing bodies outside said core or grooves on said core.

23. The new-type rotary-wing shaped fiber filter material, as recited in claim 21, wherein said rotary wings of said rotary-wing core rotate leftward or rightward, wherein a rotating angle thereof is −45°˜45°.

24. The new-type rotary-wing shaped fiber filter material, as recited in claim 22, wherein said rotary wings of said rotary-wing core rotate leftward or rightward, wherein a rotating angle thereof is −45°˜45°.

25. The new-type rotary-wing shaped fiber filter material, as recited in claim 23, wherein said lengths of said fiber bundle is same or different on two sides of said rotary-wing core, or said fiber bundle in on a single side of said rotary-wing core.

26. The new-type rotary-wing shaped fiber filter material, as recited in claim 24, wherein said lengths of said fiber bundle is same or different on two sides of said rotary-wing core, or said fiber bundle in on a single side of said rotary-wing core.

27. The new-type rotary-wing shaped fiber filter material, as recited in claim 25, wherein said fiber bundle is shaped as a straight line, a curly line, a hollow line or a heteromorphic line.

28. The new-type rotary-wing shaped fiber filter material, as recited in claim 26, wherein said fiber bundle is shaped as a straight line, a curly line, a hollow line or a heteromorphic line.

29. The new-type rotary-wing shaped fiber filter material, as recited in claim 27, wherein the fibers is natural fiber, rayon, synthetic fiber, cotton fiber, fiberglass, terylene, Nitrilon, or Jinglun, and the rotary-wing core is made by plastic, ceramic, glass, rubber or metal materials.

30. The new-type rotary-wing shaped fiber filter material, as recited in claim 28, wherein the fibers is natural fiber, rayon, synthetic fiber, cotton fiber, fiberglass, terylene, Nitrilon, or Jinglun, and the rotary-wing core is made by plastic, ceramic, glass, rubber or metal materials.
